(19) United States
(12) Patent Application Publication
(10) Pub. No.: US 2014/0126333 A1
(43) Pub. Date: May 8, 2014

(54) Doppler Angle of Attack Sensor System for Watercraft

(71) Applicant: NORTEK AS, Rud (NO)

(72) Inventors: Atle Lohrmann, Oslo (NO); Torstein Kanstad Pedersen, Oslo (NO); Robert Hopkins, JR., Santa Brigida (ES)

(73) Assignee: NORTEK AS, Rud (NO)

(21) Appl. No.: 13/670,342

(22) Filed: Nov. 6, 2012

(51) Int. Cl. G01S 15/60

(52) U.S. Cl. CPC G01S 15/60
USPC 367/91

(57) ABSTRACT

A watercraft angle of attack system includes sensors having a position locator; a heading sensor; a tilt sensor; an acoustic Doppler velocity sensor that measures velocity of the boat relative to a volume of water remote from the boat so as to reduce the boat-induced disturbance of the velocity in the volume; and a processor programmed to receive real time data from the sensors; and to compute and display angle of attack of the watercraft relative to the water.

### FIELD OF THE INVENTION

The present invention relates generally to the accurate measurement of the angle between an axis of a watercraft moving through water and its direction of motion through the water.

### BACKGROUND OF THE INVENTION

While there are many sensors that provide speed and velocity of watercraft moving through the water, there are a variety of requirements that depend on an accurate measurement of the angle of attack (AOA) of the watercraft through the water. Sailors are unable to obtain useful direct measurements of a sailboat's AOA, which they call leeway, as they sail through the water, so they depend on indirect methods. Seismic ships that use diverters to control arrays of acoustic sensors travel slowly in order to maintain control of their arrays—they depend on the lift forces of diverters to keep these arrays under control, and the lift and drag forces of the diverters vary rapidly with the diverter's AOA as it moves through the water. The efficiency of turbines that generate power from ocean currents depends on the turbine's AOA, which is its orientation relative to the flow of water. In all of these examples, the operation of watercraft is sensitive to the watercraft's AOA, and an accurate knowledge of the AOA improves the operation.

A wide variety of angles are measured for maritime applications. The cost and difficulty of these angular measurements often rises sharply with the need for measurement accuracy. An example is tilt measurement, which is typically measured by using the acceleration of gravity. However, the accelerations of the watercraft (for example caused by waves) mix with the acceleration of gravity, contaminating tilt measurements. While simple and inexpensive tilts sensors are readily available, accurate real time tilt measurements of an accelerating watercraft require complex and expensive equipment. AOA measurements are similar to tilt measurements. While AOA measurements require the measurement of the velocity of the water passing by the watercraft, the motion of the watercraft through the water also disturbs the flow and contaminates the measurements. As with tilt, there are a wide variety of applications that need an accurate knowledge of AOA, but unlike tilt, accurate real time AOA sensors are not available today.

For the purposes of this disclosure, a watercraft is defined as a body that moves through water. The traditional definition of watercraft encompasses boats and ships, both of which move through the water at the surface. This definition also encompasses craft that move under water (i.e., Kohnen U.S. Pat. No. 5,704,309). The present invention involves craft and other devices, all of which move through the water. While some of these devices are fixed to the bottom, these devices move through the water as currents flow past them. Their operation depends on their motion relative to the water. Therefore, both for simplicity and clarity, for the purposes of this patent, the term watercraft encompasses devices or objects that are fixed to the bottom but which move through the water in the reference frame of the water. An axis through a watercraft is a line that defines the watercraft's orientation.

An accurate AOA sensor will provide significant advantages for many maritime applications. In these applications, accurate real-time AOA measurements substantially improve an operator's ability to control a watercraft.

### SUMMARY OF THE INVENTION

An aspect of the invention involves a system that combines sensors and a processor to compute the angle of attack of a watercraft as it moves through the water. The critical sensor is an acoustic Doppler velocity sensor, which remotely measures the velocity vector of the watercraft relative to the water. The invention often includes tilt and position sensors as well. The processor receives and processes the data from these sensors and computes the angle, relative to an axis of a watercraft, that the watercraft takes as it moves through the water. This is the angle of attack. The system provides this angle of attack to the operator of the watercraft who can use it to enhance the operation of the watercraft.

Angle of attack is a critical parameter for many water craft and small changes in the angle of attack can have large effects on the behavior of the watercraft. Therefore, an accurate knowledge of the angle of attack is highly useful for the operators of many watercraft.

Another aspect of the invention is an improved Angle of Attack Sensor System (AOA System) that combines an Acoustic Doppler Velocity Sensor (ADVS) and a processor that computes accurate AOA measurements and reports the measurements in real time to watercraft operators, thus enhancing their ability to control their watercraft. Some AOA Systems must also integrate real time measurements from other sensors in order to obtain AOA.

The following sections describe an ADVS and explain how an AOA System comprising an ADVS combined with a processor provides operators useful AOA data in three different applications. These applications illustrate a range of AOA Systems.

AOA (100) is the angle between an axis or a reference line (110) on a watercraft (for example the keel of a boat) and the vector representing the relative motion between the watercraft and the fluid through which it is moving (120). The AOA of a sailboat is commonly called its leeway.

Watercraft that stay at the water surface normally require only one component of AOA, the horizontal component. Watercraft that move below the water surface can also use the vertical component of the AOA.

Another aspect of the invention involves a watercraft angle of attack system. The system includes an acoustic Doppler velocity sensor that measures velocity of the watercraft relative to a volume of water remote from the watercraft so as to reduce watercraft-induced disturbance of the velocity in the volume of water; a non-transitory computer readable medium configured to store executable programmed modules; a processor communicatively coupled with the non-transitory computer readable medium configured to execute programmed modules stored therein; a receiving module element stored in the non-transitory computer readable medium and configured to be executed by the processor, the receiving module element configured to receive real time data from the acoustic Doppler velocity sensor; a computing module element stored in the non-transitory computer readable medium and configured to be executed by the processor, the computing module element configured to compute angle of attack of the watercraft through water based in part on the real time data received from the acoustic Doppler velocity sensor; and a reporting module element stored in the non-transitory computer readable medium and configured to be executed by the processor, the reporting module element configured to report the computed angle of attack of the watercraft relative to the water.

One or more implementations of the aspect immediately above include one or more of the following: the system further includes a tilt sensor, and the receiving element configured to receive real time data from the tilt sensor, and the computing module element configured to compute angle of attack of the watercraft relative to water based in part on the real time data received from the tilt sensor; the system further includes a keel canting angle sensor, and the receiving element configured to receive real time data from the keel canting angle sensor and the computing module element configured to compute angle of attack of the watercraft relative to water based in part on the real time data received from the keel canting angle sensor; the system further includes a heading sensor, and the receiving element configured to receive real time data from the heading sensor, and the computing module element configured to compute the velocity of the watercraft relative to water based in part on the real time data received from the heading sensor; the system further includes a position sensor, and the receiving element configured to receive real time data from the position sensor, and the computing module element configured to compute current velocity of the water relative to the earth based in part on the real time data received from the position sensor; the computing module element is configured to compute the velocity of the watercraft relative to the earth by differentiating position data from the position sensor; the computing module element is configured to compute a plurality of current velocities based in part on the real time data received from the acoustic Doppler velocity sensor, and the displaying module element is configured to display a map of the computed current velocities; the system further includes a wind velocity sensor, and the receiving element configured to receive real time data from the wind velocity sensor, the computing module element configured to compute wind velocity in a water frame of reference, and further including a displaying module element stored in the non-transitory computer readable medium and configured to be executed by the processor, the displaying module element configured to display the wind velocity in the water frame of reference; the reporting module element is configured to report the computed angle of attack of the watercraft relative to the water to an external device; and/or the system further includes a user input and the processor communicatively coupled with the user input.

A further aspect of the invention involves a watercraft angle of attack system including a sensor assembly having a heading sensor; and an acoustic Doppler velocity sensor that measures velocity of the watercraft relative to a volume of water remote from the watercraft so as to reduce watercraft-induced disturbance of the velocity in the volume of water; a non-transitory computer readable medium configured to store executable programmed modules; a processor communicatively coupled with the non-transitory computer readable medium configured to execute programmed modules stored therein; a receiving module element stored in the non-transitory computer readable medium and configured to be executed by the processor, the receiving module element configured to receive real time data from the sensors of the sensor assembly; and a computing module element stored in the non-transitory computer readable medium and configured to be executed by the processor, the computing module element configured to compute angle of attack of the watercraft through the water and velocity of the watercraft through the water in earth coordinates.

One or more implementations of the aspect immediately above include one or more of the following: the system further includes a display module element stored in the non-transitory computer readable medium and configured to be executed by the processor, the display module element configured to display angle of attack of the watercraft and velocity of the watercraft relative to the water; the system further includes a position sensor, and the receiving element configured to receive real time data from the position sensor, and the computing module element configured to compute current velocity of the water relative to the earth based in part on the real time data received from the position sensor; the displaying module element is configured to display the current velocity; the system further includes a keel canting angle sensor, and the receiving element configured to receive real time data from the keel canting angle sensor and the computing module element configured to compute angle of attack of the watercraft relative to water based in part on the real time data received from the keel canting angle sensor; the system further includes a wind velocity sensor, and the receiving element configured to receive real time data from the wind velocity sensor, the computing module element configured to compute wind velocity in a water frame of reference, and the displaying module element configured to display the wind velocity in the water frame of reference; the system further includes a reporting module element stored in the non-transitory computer readable medium and configured to be executed by the processor, the reporting module element is configured to report the computed angle of attack of the watercraft relative to the water to an external device; and/or the system further includes a user input and the processor communicatively coupled with the user input.

A further aspect of the invention involves a watercraft angle of attack system including a sensor assembly having a heading sensor; a position sensor; a tilt sensor; and an acoustic Doppler velocity sensor that measures velocity of the watercraft relative to a volume of water remote from the watercraft so as to reduce watercraft-induced disturbance of the velocity in the volume of water; and a non-transitory computer readable medium configured to store executable programmed modules; a processor communicatively coupled with the non-transitory computer readable medium configured to execute programmed modules stored therein; a receiving module element stored in the non-transitory computer readable medium and configured to be executed by the processor, the receiving module element configured to receive real time data from the sensors of the sensor assembly; a computing module element stored in the non-transitory computer readable medium and configured to be executed by the processor, the computing module element configured to compute: angle of attack of the watercraft relative to water; velocity of the watercraft through the water in earth coordinates; and current velocity of the water relative to the earth.

One or more implementations of the aspect immediately above include one or more of the following: the system further includes a wind velocity sensor, and the receiving element configured to receive real time data from the wind velocity sensor, the computing module element configured to compute wind velocity in a water frame of reference, and the displaying module element configured to display the wind velocity in the water frame of reference; and/or the computing module element is configured to compute a plurality of current velocities based in part on the real time data received from the acoustic Doppler velocity sensor, and the displaying module element is configured to display a map of the computed current velocities.

### Acoustic Doppler Velocity Sensor (ADVS)

ADVSs were introduced commercially around the 1970s in the form of Doppler Velocity Logs, which measure the velocity of ships (200), and Acoustic Doppler Current Profilers (ADCPs), which oceanographers use to measure ocean currents. An ADCP uses acoustic beams (210) that measure velocity remotely from the ship. ADVSs that measure three-dimensional velocities require multiple beams. ADVSs measure velocity in limited volumes (220) called range cells or bins. ADVSs mounted on ships typically have an acoustic transducer assembly (230), a cable (240) and an electronics unit (250).

The important capability of an ADVS is that it measures water velocity in volumes of water 220 that are remote from the watercraft. A volume is “far enough” from a watercraft if the watercraft's disturbance is sufficiently small so that the errors produced by the watercraft's disturbance are acceptably small. Acceptably small errors produce measurement with sufficient accuracy to be useful in their application. ADVSs are the only instruments available today that make such remote measurements.

An ADVS needs at least three beams to measure all three components of the vector velocity of the ADVS relative to the water. Three beams are sufficient to obtain the three dimensional velocity. The addition of a fourth beam adds redundancy that provides an error check and that improves the measurement accuracy. ADVSs commonly have the ability to detect obstacles in the beams and to reject them. An ADVs mounted on a sailboat can get so close to the surface that one of its beams could be contaminated by direct reflections from the surface. When that happens, a four beam ADVS would reject the measurement in that beam, which still leaves three good beams the ADVS can use to compute velocity.

ADVSs have been used to study leeway in drifting objects, for example by the US Coast Guard (ref: Allen, et al., 1999). Leeway of an object drifting at the sea surface is defined by Allen as the velocity vector of an object on the surface relative to the local background surface currents. Leeway defined this way is not the same as the AOA or leeway of a sailboat. ADCPs used in these drifting object leeway studies recorded remote velocity measurements internally for subsequent analysis, and they did not provide real time data.

### Racing Sailboats

A sailboat's AOA (300) is a critical factor affecting its speed through the water. Leeway is sailing terminology for the boat's AOA; leeway is the angular difference between the boat's heading (310) and its actual direction of motion through the water (320). Leeway is caused by the boat's sideways velocity (340), which is primarily the result of wind and wave forces. Leeway should not be confused with the angle of the sailboat's sails relative to the wind, which some sailors call the sailboat's angle of attack. While the general concept is the same (because both air and water are fluids), the term AOA in this disclosure refers specifically to AOA of a watercraft relative to the water.

Leeway has been exceptionally difficult to measure because leeway is usually a small angle. Small variations in leeway have a large effect on the sailboat. It is also difficult to measure because it requires an accurate measure of the boat's sideways velocity. Sideways velocity is far more difficult to measure than boat speed and it is contaminated more by the watercraft's hull. Most leeway sensors attempt to measure leeway directly, using vanes mounted to the hull or near it (Green, U.S. Pat. No. 4,059,993; Mascia, U.S. Pat. No. 4,088,019). However, boat hulls deflect the flow as they pass through the water, creating flow deviations and vortices, which introduce errors into the leeway measurements rendering the sensors largely useless. Current sensors oriented to measure the sideways component of flow have the same problem as vanes, plus the additional problem of trying to measure a small sideways velocity 340 in the presence of a large forward velocity 350.

A sailboat AOA System recently installed on a racing sailboat provides a comprehensive example of this invention. The sailboat is the PUMA Ocean Racing Team's Mar Mostro, a racing yacht 400 (represented schematically in the figure) entered into the 2011-2012 Volvo Ocean Race. The Mar Mostro AOS System was first publicized in a press release in November 2011. The press release described its AOA System as a Doppler Velocity Log (which is an ADVS) integrated into the boat's navigation system.

The Mar Mostro racing sailboat 400 (represented schematically) is an advanced sailboat designed to sail in deep water in around-the-world races. It employs a canted keel 410 with a heavy streamlined weight 420 at the bottom called the lead bulb. The lead bulb has a diameter of around 0.5 m and a length of around 4 m. Its ADVS 430 consists of a transducer assembly and an electronics module, both designed to fit in the smallest possible volume within the lead bulb; the ADVS must be small because the lead bulb requires a high density in order to work effectively. This is because the lead serves as ballast on a moment arm. Displacing lead in the bulb with something less dense at this crucial location translates into reduced righting moment and lower speed for the boat. The boat's navigation system 440 is also the AOA System's processor.

The ADVS transducer assembly 500 is mounted in a small cavity 510 at the base of the lead bulb 520. It includes an acoustically transparent cover 530 that fills the cavity and fairs the transducer assembly smoothly into the surface of the lead bulb to reduce drag, and that eliminates bubbles that would otherwise collect in the cavity. The transducer assembly holds four transducer ceramics 540 that transmit and receive high frequency acoustic signals into the water. A cable 550 connects the transducer to the electronics 560 at one of the two connectors 570. The other connector 570 is for a cable that goes through the keel to the boat's navigation system above. The electronics module is packaged in a watertight box 560 approximately 60 mm×100 mm×250 mm that fits under a cover inside a shallow cavity on the lead bulb. The transducer connects to the electronics through a cable and an underwater connector, and the electronics box connects to the navigation system processor through another cable. These cables are designed to be easily run inside the lead bulb and through the keel.

The Mar Mostro AOA System is relatively complex and other AOA systems may be less complex. Therefore, the following detailed explanation of this AOA System serves as a generally comprehensive explanation of the preferred embodiment of an AOA System. This system can be adapted as it is to any envisioned AOA System. Some AOA systems can be simplified by removing elements of the preferred embodiment.

Sailboat ADVSs can be prone to picking up electrical noise from motors and electronic gear in the boat. This problem was corrected in the Mar Mostro by adding filters to the power supply wires in the cable between the electronics and the navigation processor. Similar filters will often be required in other sailboats, and in other wires than just the power supply wires.

The Mar Mostro navigation system includes a processor that is programmed to perform the signal processing necessary to convert the ADVS measurements and sensor data into a measurement of the sailboat's AOA and to report the AOA in a form useful to the boat's operators. The Mar Mostro team uses its real time leeway measurements to optimize the sailboat's sailing performance. The AOA System measures the velocity of the boat through the water 600 and the navigation system (i.e. its position sensor) measures its velocity relative to the earth 610. The difference between these two velocities is the ocean current velocity 620. Therefore, its AOA System also reports ocean current measured from the sailboat, which the team uses in its routing decisions. The racing team receives this information in a format they can use, and the information is sufficiently accurate and timely to be useful to them as they sail.

A sailboat AOA System requires the use of an ADVS to produce AOA measurements that are sufficiently accurate to be useful. There are many reasons why ADVSs have not been used on sailboats in the past. Until recently, ADVSs were too large to fit on a sailboat. Unlike ships, sailboats travel with large, continuous heel angles. Sailboats are much smaller and more weight sensitive than ships carrying ADCPs and they often sail in rough, windy weather. Bubbles created by the boat's bow wave and entrained along the hull surface interfere with the operation of the ADVS. Sailboats accelerate and decelerate more rapidly than ships, and are disturbed more by waves, so water velocity measurements need to be sampled at a higher frequency. The hydrodynamic forces imparted by a sailboat's keel greatly increase its disturbance of the flow. However, by far the most important reason is that existing ADVS systems do not provide sailors with a sailboat's leeway in real time.

The Mar Mostro is an exceptionally sophisticated sailboat, and many other sailboats are simpler. For example, ADVSs on sailboats with fixed instead of canted keels have no need for the sensor that measures the keel canting angle, and they can either skip the step that rotates the measurement by this angle, or rotate it with an angle of 0, which has the same effect as skipping the rotation.

Sailboats with canted keels 700 can mount an ADVS 710 in its lead bulb 720 at the end of the canted keel 725. Sailboats without canted keels 730 (for example) could mount the ADVS at the end of a fixed keel 740, or on the hull 750.

Mounting an ADVS on the end of a fixed keel might require enlarging the keel to hold a standard ADVS transducer (i.e., 500), or installation of a streamlined ADVS transducer 800 in which the beams are mounted all in a line. Such a transducer could incorporate four transducer ceramics 810 pointed in four different directions 820. It could include a small circuit board for transducer electronics 830 and could be packaged in a plastic housing 840, which could incorporate acoustically transparent plastic. The package could be faired smoothly into the keel 850. Because there are many different designs for keels, this is only one example of designs that are advantageous for fixed keels.

Not all ADVSs require acoustically transparent covers. ADVSs can be manufactured with a flat transducer face, which makes it easier to fit them into, for example, a hull, while creating hydrodynamically smooth surfaces. Not all sailboat navigation systems include positioning systems, or positioning systems that provide useful earth-referenced velocity measurements. An AOA System on such a sailboat could still provide the boat valuable real time leeway, but it would not be able to measure the ocean current velocity.

Some sailboats could benefit from an AOA System even if there were no sensors measuring tilts, angles, or heading. Such an AOA System could comprise only an ADVS and a processor. In order to produce a useful leeway angle when a sailboat heels over, as shown in FIG. 9, the processor could compute leeway by mathematically constraining the velocity to be purely horizontal. It would do this by computing the sideways 910 and vertical 940 velocities of the sailboat in boat coordinates, then computing the roll angle 900 required to make the surface reference vertical velocity 930 zero. The computed surface referenced sideways velocity 920 that results from this procedure is sufficient to compute an accurate leeway angle 300.

Sailboats sail in the reference frame of moving water, and they optimize their sails for wind that blows relative to the water. A sailboat without a navigation system can only measure the wind velocity relative to the moving sailboat. The addition of velocity measured relative to the earth enables the computation of wind velocity relative to the earth. The further addition of an AOA System that provides ocean current velocity enables the computation of wind velocity relative to the moving water, and that is the most useful measure of wind for a sailboat.

While leeway sensors have long been available (Greene, U.S. Pat. No. 4,059,993; Mascia, U.S. Pat. No. 4,088,019; Mounce, U.S. Pat. No. 4,340,936), existing sensors produce measurements with too little accuracy to be generally useful. As a result, sailors rely instead on indirect methods. One common method is to estimate leeway using rules of thumb based on other variables such as the heel angle and the boat speed. Such estimates are of relatively little use for controlling a boat when compared to the data provided by an AOA System. Another means to get leeway is to compare the boat's compass heading with its actual course over the earth (Gideon, U.S. Pat. No. 6,308,649). The problem is that this approach assumes that there is no current, while in fact there is always some current, slight or strong.

An advantage of an AOA System is that its accurate AOA measurements enable it also to produce accurate measurements of the ocean current. Sailors who know the leeway of their boats in real time can optimize the speed of the boats in the water. Sailors who know the ocean current velocity can develop a better strategy for the route they will use to get through the course. Sailors who know both can proceed through a course more quickly than those who do not.

An AOA System also provides significant advantages to the sailboat's designers. It enables them to measure leeway (AOA) to evaluate the sailboat's performance after design changes, which enables them to understand the pros and cons of design modifications. An AOA System helps designers optimize the boat's performance.

Sailboat racecourses 1000 consist of a sequence of waypoints, usually denoted by marks 1010. While the shortest path from one waypoint to another is a straight line, the route that gets a boat from one waypoint to the next may deviate considerably from this straight line. Currents 1020 and 1030 can vary considerably over a course and may be more favorable away from the straight-line path. Boats that take advantage of these favorable conditions can reach a waypoint faster than they would by staying near the straight-line path.

An AOA System can provide measurements of current along the path taken by the boat, and the navigation system can plot vectors 1040 representing the current measurements on the map. Sailors plan their courses on the basis of wind and current maps, based on historical data, satellite data, and regional forecasts as well as the measurements they make. What sailors encounter often deviates considerably from what they expect on the basis of this information. Therefore, the addition of real time current data measured on their boats enables them to improve their forecasts of wind and current. Sailors use their knowledge of the winds and currents to plan their strategies for the paths they will take through their course. In the example map 1000, a sailor could perceive an oceanic front 1050 across which the currents change direction. He could take advantage of the favorable current 1030 by designing his tacks to spend more time in this favorable current.

Sailing skill requires the management of many different aspects of a sailboat. This management includes continual adjustments to components of the sailboat. However, whenever sailors make adjustments that affect leeway, the immediate and accurate knowledge of leeway enables sailors to optimize the adjustments to obtain the sailboat's optimum performance.

Sailboat racing is a big business and it can cost millions of dollars to participate in a race. Races are often won by small margins, so incremental improvements can have a large effect on the outcome of a race. Many teams depend on sponsorship, and a team's financial support depends heavily on its ability to sustain high performance. Real time AOA measurements will therefore add considerable value for sailboat racers.

### Submerged Watercraft

There are a variety of watercraft that travel through the water below the water surface. Examples include autonomous underwater vehicles (AUVs), remote operated vehicles (ROVs), and underwater gliders. Unlike watercraft that stay on the surface, AOA for submerged watercraft is two-dimensional; its AOA adds a vertical orientation angle to the horizontal angle of a boat's AOA. The vertical component of a submerged watercraft's AOA can play an important role in the watercraft's performance. For example, the vertical component of the AOA affects the watercraft's efficiency in terms on how far it can go for a given energy consumption. The vertical component of the AOA could improve the watercraft's ability to reach a target location on the bottom, in the interior or at the surface. Measuring the vertical component of the AOA enables operators to control the AOA, which can play a role in how well the submerged watercraft performs its function.

Submerged watercraft use the same sensors as a surface watercraft, and they may also need additional sensors. For example, a submerged watercraft operated from a surface vessel can use the vessel's navigation system, but would also require a system to establish the watercraft's location relative to the surface vessel. Positioning relative to the vessel could comprise, for example, acoustic (i.e. ultra-short baseline, USBL, acoustic systems) and inertial methods. Watercraft can also determine their location by using acoustic pingers mounted on or above the bottom. The pingers could be connected into a system or network. Communication between the vessel and the submerged watercraft could comprise various acoustic, wire cable, fiber optic, and radio methods.

A submerged watercraft that includes an AOA System, and that knows its location is able to measure ocean current much the same as a surface watercraft.

### Seismic Survey Diverters

Modern seismic surveys are carried out from ships towing seismic arrays consisting of parallel strings of acoustic receivers behind them. Large seismic arrays hold typically 6 (or so) streamers, each typically 10 km long. These streamers can be spread apart over a distance of 1 km or more. Diverters 1100 are used to hold these streamers in place, providing tension to pull them apart and keep them separated. Diverters include floats 1110 to keep them at the surface and fins 1120 to provide the lift force that holds the seismic cables in place. Diverters are typically connected to the ship with cables 1130 and bridles 1140 at the end that control the diverter's orientation 1150 relative to the direction of forward motion 1160. The diverter orientation is the direction defined by an axis line that runs through the diverter. The difference between the diverter orientation and the direction of forward motion is its angle of attack 1170.

Lift force 1180 provides the tension required to separate the streamers, and is perpendicular to the direction of forward motion. Drag force 1190 is opposite the direction of forward motion, and therefore affects the amount of fuel required to run the survey.

As shown in chart 1200, lift 1210 and drag 1220 forces, and their ratio 1230 vary considerably with AOA, even for small differences in AOA. Both lift and drag are important in controlling the seismic arrays, and loss of control could cause the array to collapse, allowing streamers to entangle producing an expensive mess. Ocean currents further complicate the situation because they can differ considerably from one side of the array to the other. The forces in chart 1200 depend on the angle of attack based on the direction of motion through the water. Ocean currents cause this direction to differ from the direction of forward motion of the seismic ship.

A typical AOA system for a diverter comprises an ADVS 1300 and a sensor package 1320, both mounted on the diverter. Data collected at the diverter is sent back to the ship, for example, by radio telemetry, where it goes into the AOA System's processor, which computes both AOA and the ocean currents. A ship's navigation system often comprises the AOA System's processor. The diverter's ADVS makes measurements in volumes 1330 that are remote from the diverter. Horizontal beams 1340 provide AOA and near surface current, and beams that slant downwards 1350 provide current from lower levels of the water.

Seismic surveys tend to follow straight tracks, after which they turn around to go in the opposite direction. These turns take a long time to complete because operators must maintain wide safety margins in order to keep the array from collapsing. The addition of an AOA System that provides real time AOA and ocean current enables seismic operators to operate safely with smaller safety margins, which speeds up turns and reduces overall cost.

Some diverter AOS Systems benefit from the addition of heading and position sensors (i.e., GPS). The addition of a heading sensor enables operators to monitor the orientation of a diverter relative to the survey's path. While diverters tilt less than sailboats, they do tilt some, and AOS Systems with tilt sensors can use the tilt measurements to improve AOA and ocean current measurements.

Operators who know both AOA and ocean current at their diverters in real time are able to make more effective real-time adjustments to keep control over their seismic arrays. As they gain experience operating their arrays while receiving this information, they develop insight that enables them to reconfigure their arrays for the next survey to further improve their operation. AOA Systems are also valuable in the design phase of new diverters. The information helps designers develop better diverters and better ways of cabling them to the ships and seismic arrays. When they make design changes, their ability to measure AOA and ocean current enables them to evaluate the results of their changes both more quickly and more accurately.

### Turbines That Generate Power From Ocean Currents

Turbines 1400 and propellers that generate electricity from ocean currents are examples of stationary devices that are sensitive to the motion of water flowing past them. Although fixed to the bottom 1410, these devices move through the water in the water's frame of reference. The part of the turbine that generates electricity 1420 must rotate to face the current in order for the turbine to work. A turbine's energy generation efficiency depends, among other things, on its AOA 1500, which is the difference in direction between the turbine's axis 1510 and the direction of the ocean current 1520. The turbine's axis is typically the centerline of the shaft around which the turbine blades rotate. Small AOA offsets can make a large difference in the output of the generator.

An AOA System on a seabed-mounted turbine is simpler than one on a sailboat. Since the turbine is fixed to the seabed, there is no need for a positioning system. A minimum AOA System on a turbine could consist of nothing but an ADVS and a processor, with no other sensors. Such a system would be sufficient to enable the turbine operator to keep the turbine's AOA in its optimum range and therefore to maximize the turbine's efficiency.

Turbines are not the only devices that generate ocean energy, and that operate in ways that are sensitive to an angle of attack. Any device that operates in the ocean such that its operation is sensitive to an angle of attack will benefit from an AOA System that measures its AOA in real time.

### Tethered Watercraft

Watercraft can be tethered to the bottom, to a float, or to a structure above the bottom so that the watercraft rotates freely in the flow. Such watercraft are useful for a variety of purposes, which can include environmental monitoring and power generation. An AOA System on a tethered watercraft can be useful for optimizing the watercraft's performance, including its ability to harvest energy from the flow, its ability to establish and maintain its location in the water, and its ability to make its intended measurements.

Tethered watercraft can benefit from the vertical component of AOA, the same as submerged watercraft.

### BRIEF DESCRIPTION OF THE DRAWINGS

FIG. 1 is a schematic view illustrating a boat's angle of attack (AOA).

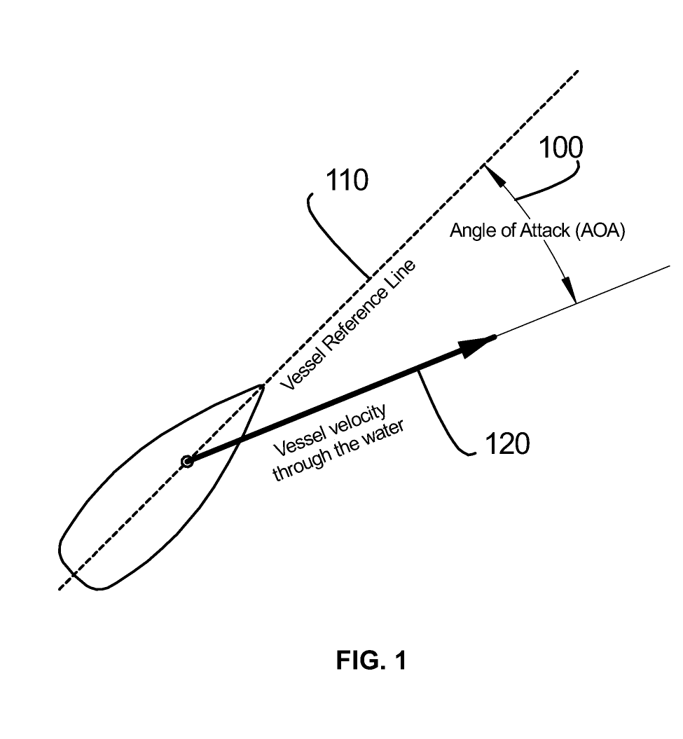

FIGS. 2A and 2B are a perspective and a side elevational view illustrating an Acoustic Doppler Velocity Sensor (ADVS) mounted on a ship.

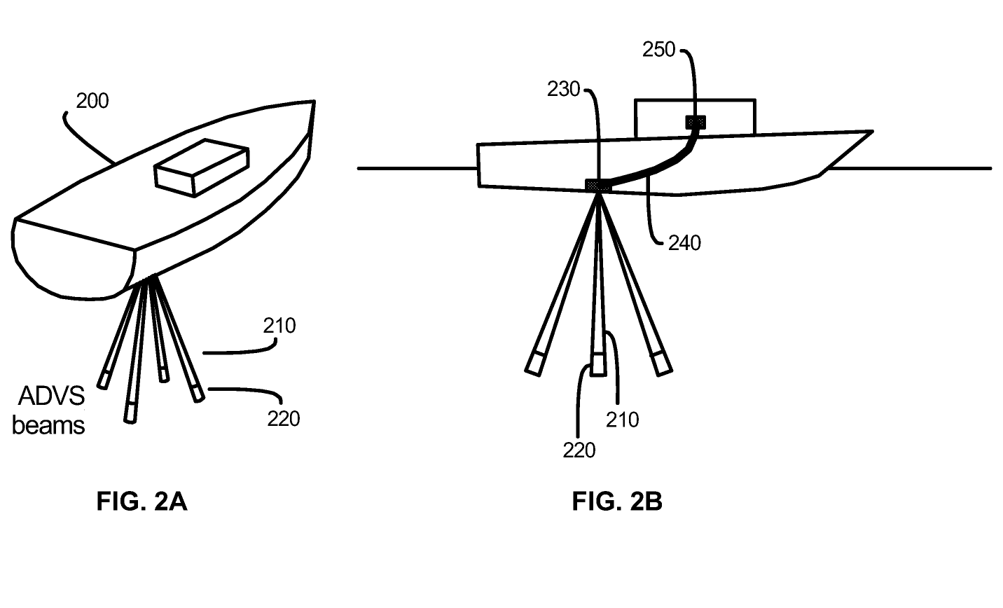

FIG. 3 is a schematic view illustrating a sailboat's AOA, which on a sailboat is called leeway.

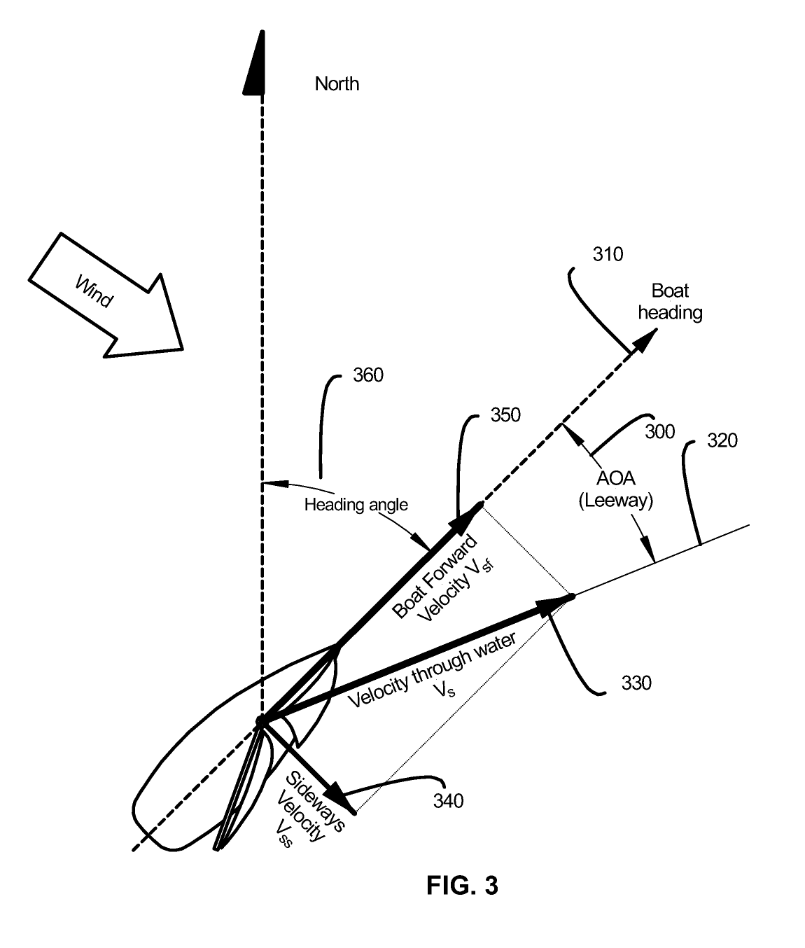

FIG. 4 is a perspective view illustrating the components of an AOA System on a racing sailboat.

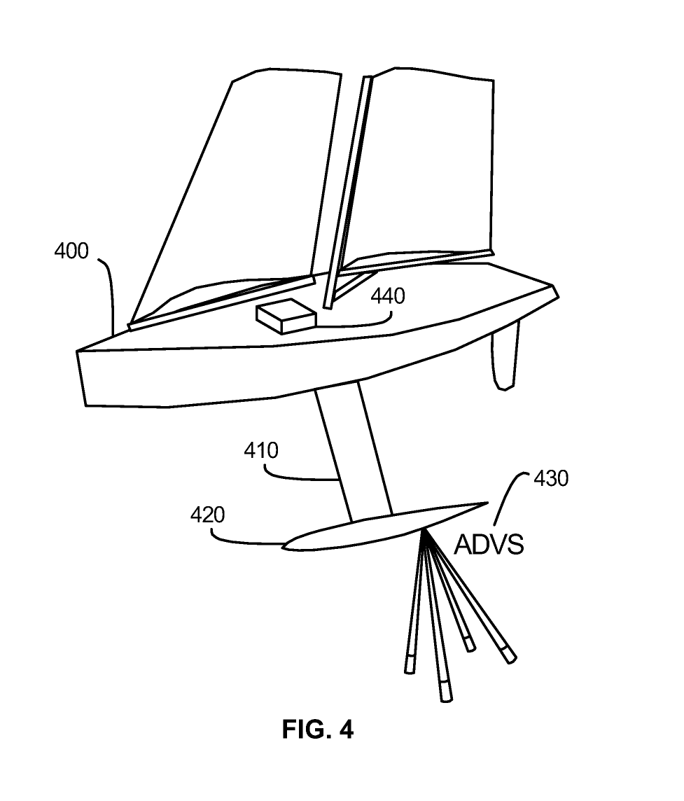

FIGS. 5A, 5B, and 5C are a cross-sectional view, a cross-sectional view, and a perspective view illustrating the main components of the ADVS mounted on the racing sailboat of FIG. 4.

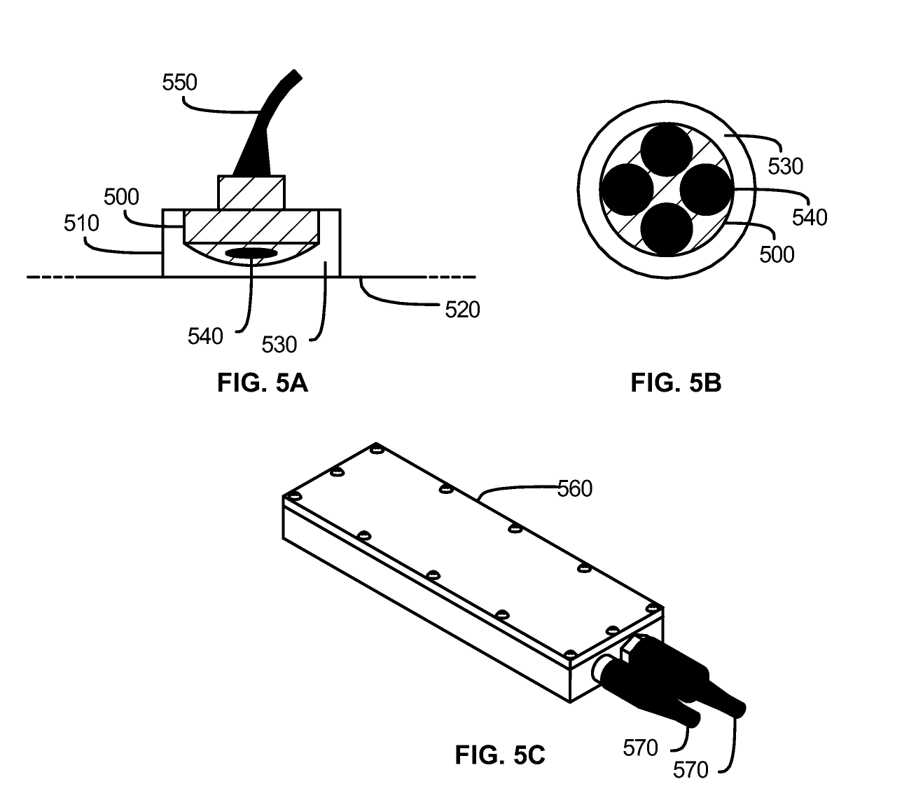

FIG. 6 is a schematic view illustrating velocity vectors shown for computation of ocean current velocity.

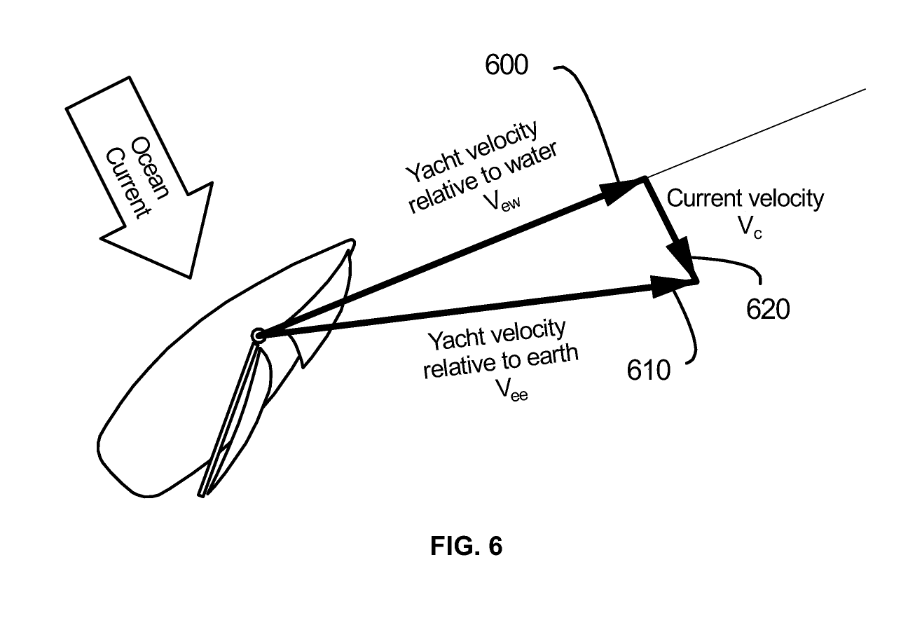

FIG. 7A-7C are end views illustrating several different ways of mounting an ADVS on a sailboat, and illustrating a boat's heel angle and the canting angle of a canted keel.

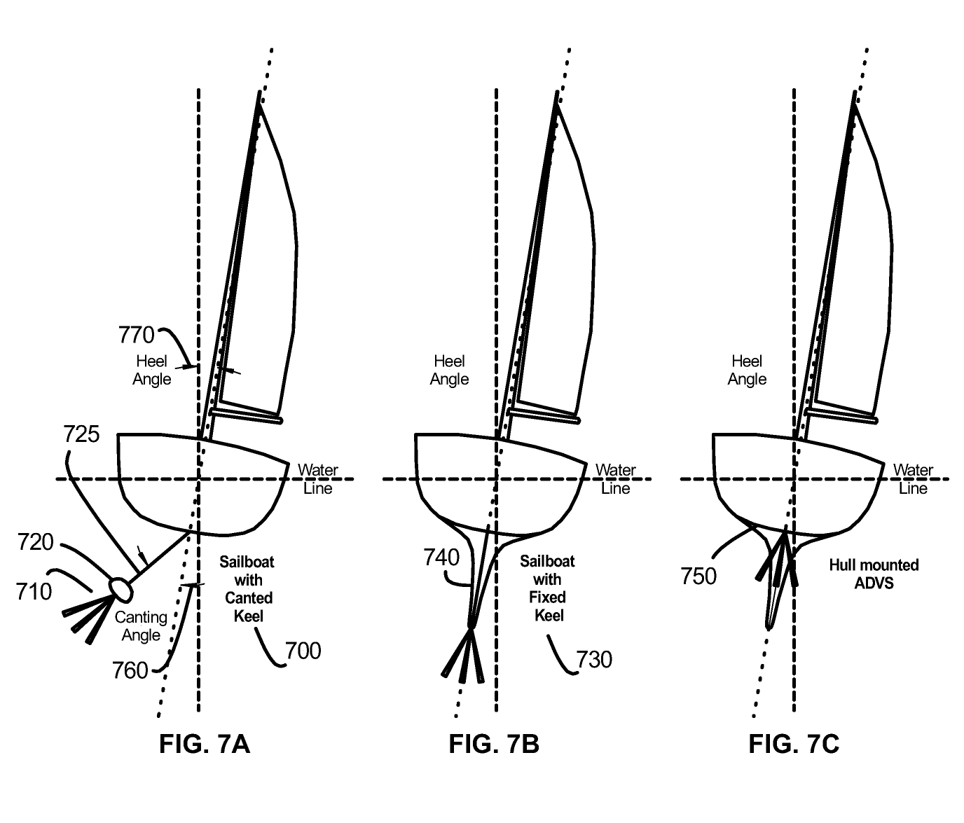

FIGS. 8A, 8B, and 8C are a side view, an end view, and a top view illustrating an ADVS transducer such as might be mounted on the end of a keel.

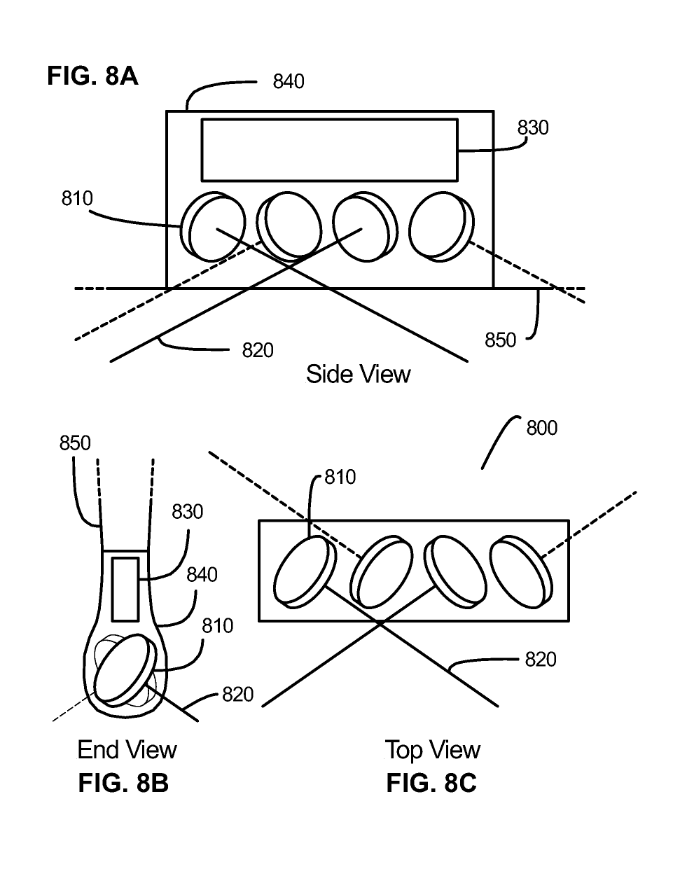

FIGS. 9A and 9B are end views illustrating surface referenced boat coordinates.

FIG. 10 is a top view illustrating an example sailing race course, showing current vectors mapped over the course and related to an ocean front.

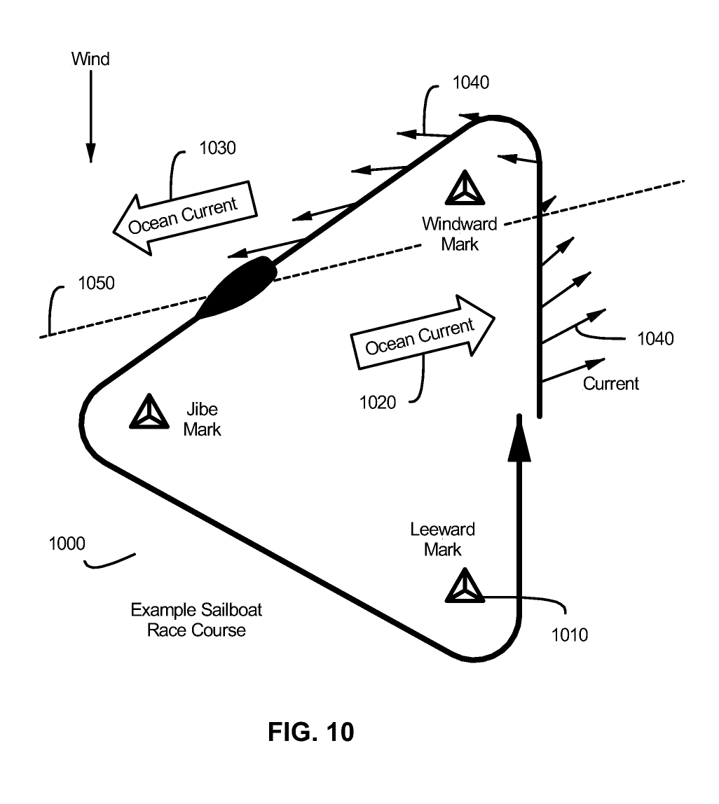

FIGS. 11A and 11B are a side view and a top view illustrating a seismic survey diverter, its AOA, and its lift and drag forces.

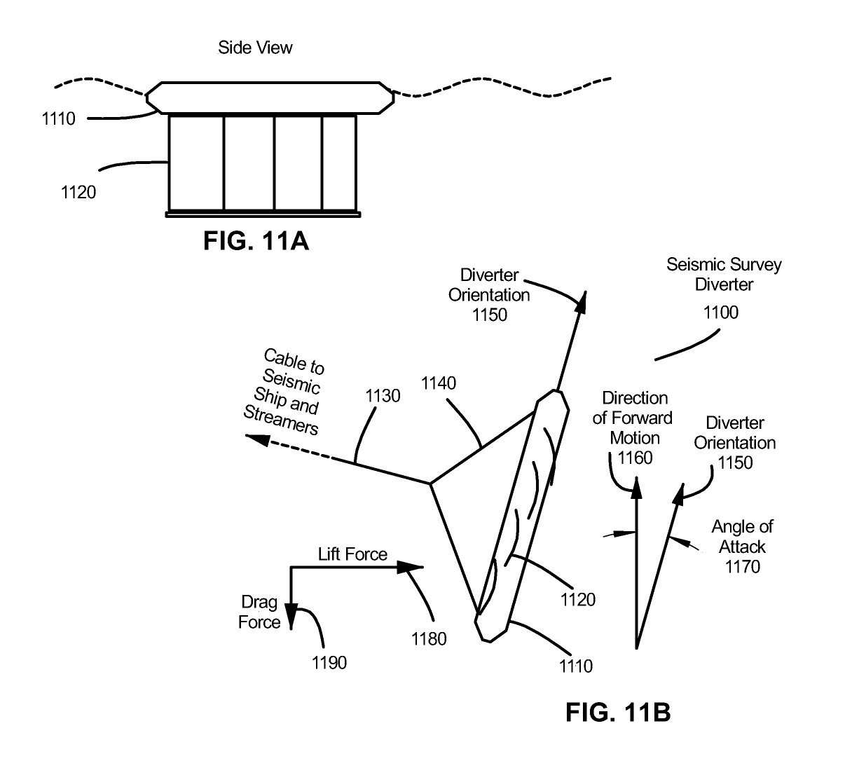

FIG. 12 is a chart illustrating how a diverter's lift and drag forces can vary with AOA.

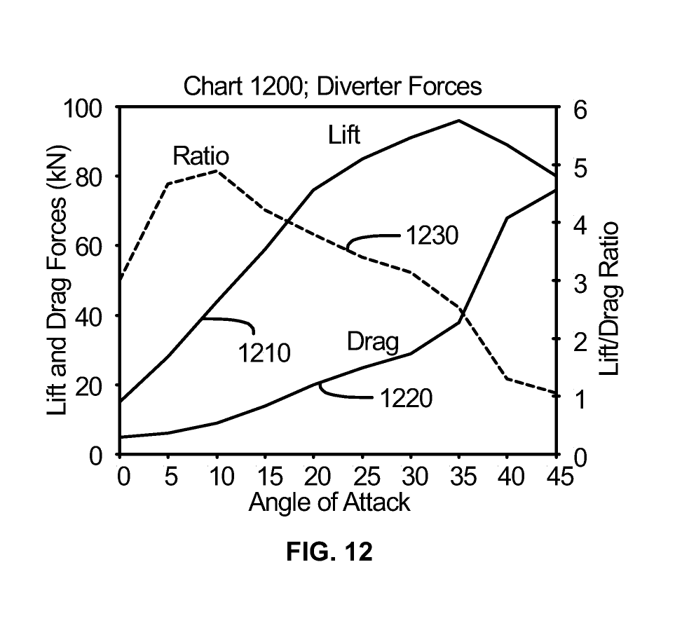

FIGS. 13A and 13B are a side view and a top view illustrating an ADVS mounted on a diverter.

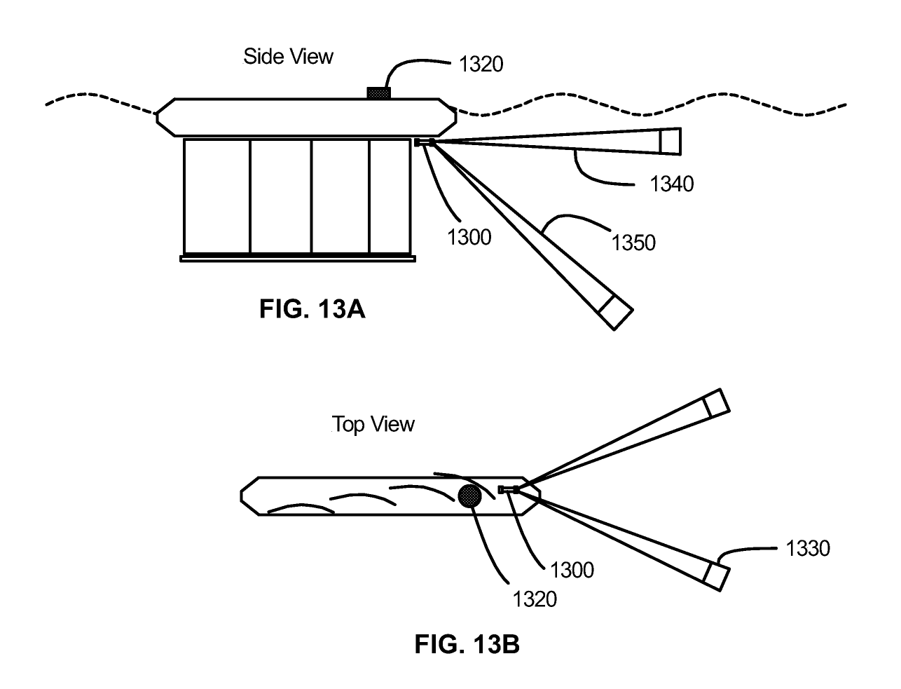

FIG. 14 is a perspective view illustrating a turbine used to generate power from ocean currents.

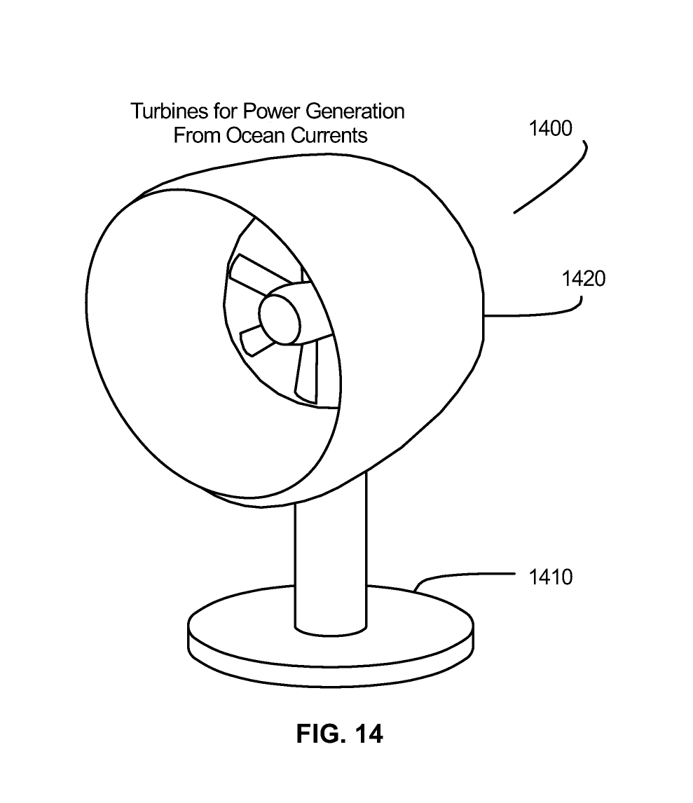

FIG. 15 is a top view illustrating a turbine's AOA.

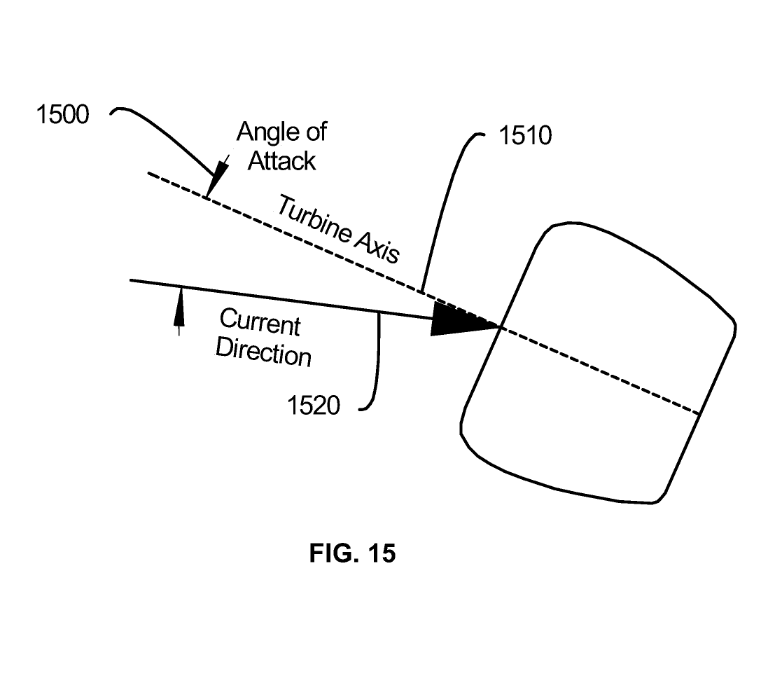

FIG. 16 is a block diagram illustrating the main components of an AOA System

FIG. 17 is a flow chart illustrating the processing that must be performed by the processor.

FIG. 18 is a block diagram illustrating an example wired or wireless processor enabled device that may be used in connection with various embodiments described herein.

### DETAILED DESCRIPTION OF A PREFERRED EMBODIMENT

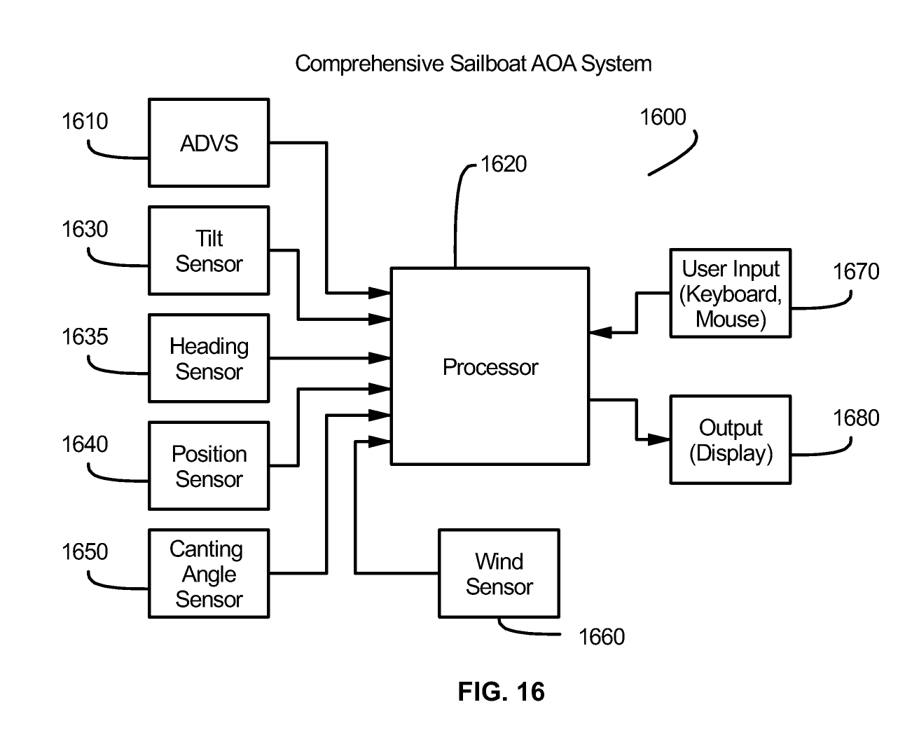

With reference to FIG. 16, an embodiment of a comprehensive AOA System 1600 for a racing sailboat will be described. The racing sailboat uses the comprehensive AOA System 1600 because it requires a comprehensive set of sensors and requires implementation of a comprehensive set of processing steps. Such a system 1600 is readily simplified for use in simpler watercraft than a racing sailboat all the way down to an AOA System 1600 on an ocean power generation turbine. A sailboat's AOA System 1600 comprises an Acoustic Doppler Velocity Sensor (ADVS) 1610 and a processor 1620. The system also comprises a variety of sensors, some of the most common ones being shown in the AOA System 1600. The sensors of an AOA are assembled in various forms. A sensor assembly may contain a single module combining all the necessary sensors, or the assembly can contain multiple modules, each with one or more sensors.

The watercraft's tilt sensor 1630 reports the watercraft's pitch and roll measurement. Pitch is the watercraft's tilt associated with the rise or fall of the fore or aft ends of the watercraft. Roll is the watercraft's sideways tilt such as heel or list. Roll is typically a rotation around the watercraft's axis. The heading sensor 1635 reports the direction of an axis of the watercraft. The position sensor 1640, commonly a GPS, provides the location of the watercraft relative to the earth. Position sensors often measure and output a watercraft's velocity (i.e. the rate of change in position) relative to the earth. When position sensors do not report velocity, the AOA processor can differentiate the position data with respect to time to determine the watercraft's velocity relative to the earth. When sailboats have an ADVS mounted on a canting keel, the AOA System benefits from the addition of a sensor that measures the canting angle 1650. Including the data from a wind sensor 1660 allows the AOA System to report the wind velocity relative to the moving water.

A complete AOA system also includes various methods for accepting user input 1670 such as a keyboard, mouse, or touch screen, and it provides an output 1680 of useful information to the crew, for example through a display. Some AOA systems could output information in a digital data stream for a variety of purposes, for example, to control devices on the sailboat such as devices that adjust trim or ballast.

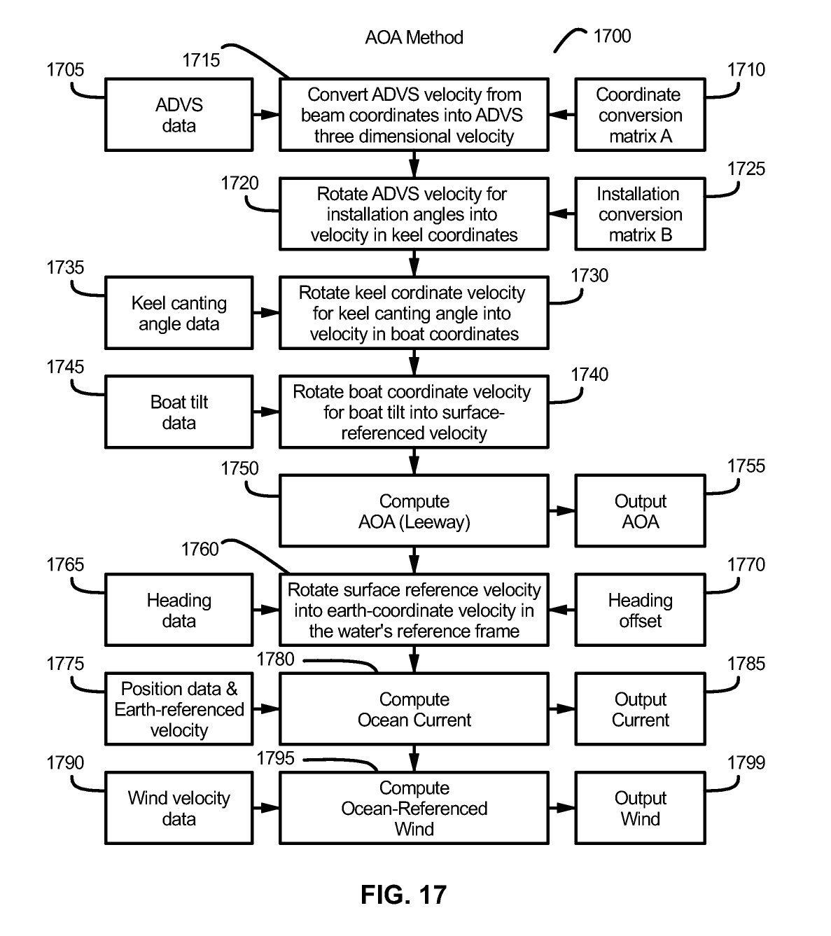

With reference to FIG. 17, the processor 1620 is programmed to perform AOA method 1700. An ADVS measures a velocity in each beam in beam coordinates, which is the velocity parallel to the beam. The velocity measurement comes from a remote volume 220 (some ADVSs measure multiple remote volumes). An ADVS has typically 3 or 4 beams. In the embodiment shown, the ADVS includes four beams. Some AOA Systems could use an ADVS with only two beams. The ADVS data 1705 consists of the ADVS velocity vector Vᵣ, which is raw velocity in beam coordinates. The raw velocity comprises a velocity parallel to the beam in each of its remote measurement volumes. Conversion from beam coordinates into an orthogonal coordinate system requires the beam angle data; the direction of each beam can be determined by a pair of angles in a coordinate system defined relative to the transducer head. Given the beam angles, a coordinate conversion matrix A 1710 can be derived using trigonometric relationships. The matrix A is normally provided by the ADVS supplier; it can either be input to the processor by users or hard coded. In some systems, this conversion is performed internally inside the ADVS.

The first step 1715 converts Vᵣ into three-dimensional velocity in ADVS coordinates, Vₐ, using the equation Vₐ=A Vᵣ. The velocity Vₐ is in an orthogonal coordinate system that is normally defined and documented by the ADVS supplier.

The next step 1720 rotates Vₐ into velocity Vₖ in the coordinate system of the keel bulb. The keel bulb coordinate system is defined by the sailboat designer and is the same as the sailboat's coordinate system except for the canting angle of the keel. The equation converting velocity into the keel coordinate system is Vₖ=B Vₐ, where B is a rotation matrix 1725 that incorporates the installation angles of the ADVS, which are determined after the ADVS is installed. B is derived using trigonometric relationships. The matrix B can be input into the processor by users or it can be hard coded.

The next step 1730 rotates Vₖ to velocity in sailboat coordinates V_{b} with a rotation matrix C that corrects for the canting angle 760 of the keel. C is computed internally inside the processor as part of step 1730 using the keel canting angle data 1735 from the canting angle sensor input. The rotation is V_{b}=C Vₖ. Sailboat coordinate velocities consist of a forward velocity parallel to the axis of the hull, sailboat upward velocity, i.e., the velocity perpendicular to the forward velocity and in the direction of the mast, and sideways velocity.

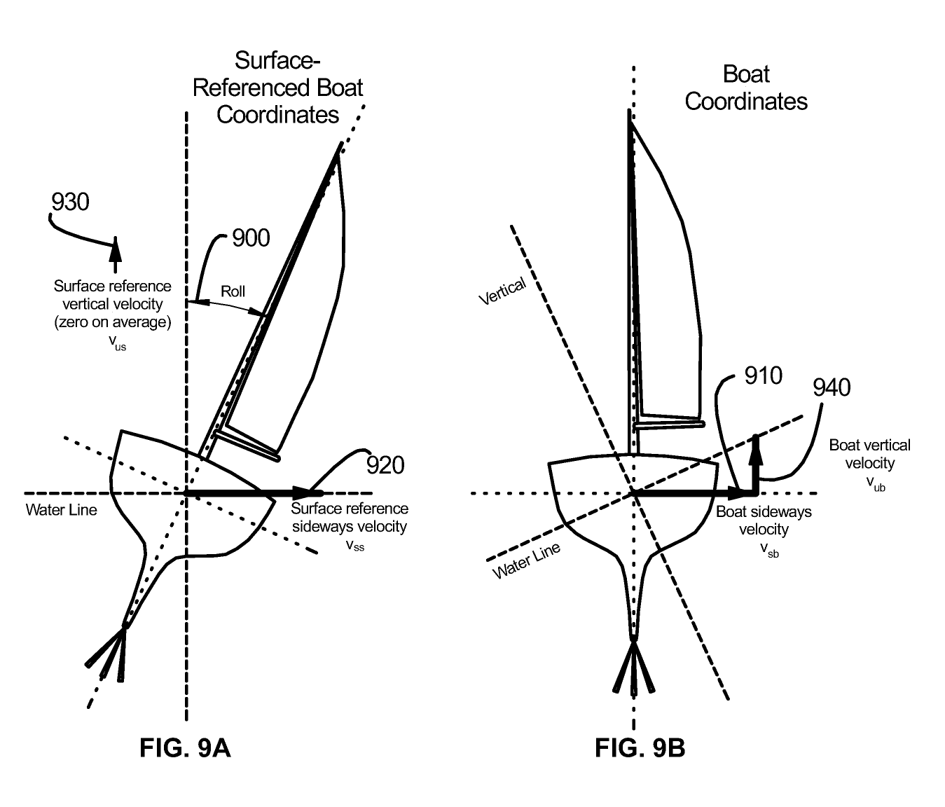

The next step 1740 rotates V_{b} to surface-referenced velocity Vₛ 330 using tilt sensors on the sailboat, which measure pitch and roll (heel 770 in a sailboat). The rotation is Vₛ=D V_{b}, where D is a rotation matrix computed inside the processor using the boat tilt data 1745. With reference to FIG. 9, the primary correction is for the boat's roll 900 or heel, which is the main tilt experienced by a sailboat. The other tilt, pitch, is normally much smaller. The main change is seen in the conversion of boat sideways velocity V_{sb} 910 to surface-referenced sideways velocity Vₛₛ 920. Sailboats are different from ships because they sail with continuous large tilts when they heel under the influence of the wind. Conversion from boat coordinates to surface reference coordinates is a necessary step for sailboats that would not be envisioned for a ship. Because ships tilt relatively little compared with a sailboat, V_{b} and Vₛ are nearly identical for a ship. Since a sailboat is constrained to stay on the sea surface, the average surface referenced vertical velocity Vᵤₛ 930 is zero.

The next step 1750 is the computation of AOA, i.e., the sailboat's leeway 300. The horizontal components of Vₛ include the sailboat's forward velocity, V_{sf} 350, and sideways velocity, Vₛₛ, 340. A sailboat's AOA is the direction of the boat's velocity in surface-referenced coordinates, or arctan(Vₛₛ/V_{sf}). The AOA can now be output for display 1755.

The next step 1760 rotates Vₛ to earth-coordinate velocity V_{ew} 600 using the boat's heading angle 360, using the rotation V_{ew}=E Vₛ, where E is a rotation matrix that is computed by the processor using the ship's heading data 1765. Earth-coordinate velocity consists of velocity components directed toward true north, true east and up or down. Since most ship's compasses use the earth's magnetic field to determine heading, the computation must account for a heading offset 1770 representing the difference between magnetic heading and true north. The value can be input to the processor or the processor can determine it based on stored maps and the boat's location. Note that V_{ew} is the velocity of the sailboat in earth coordinates, but in the frame of reference of the water, which moves with the ocean current.

The velocity V_{ew} is offset from the sailboat's velocity relative to the earth, Vₑₑ 610, by the velocity of the ocean current, V_{c} 620. These are related by the equation Vₑₑ=V_{ew}+V_{c}. Note that V_{c} is always measured relative to the fixed reference frame of the earth. This equation can also be written V_{c}=Vₑₑ−V_{ew}. The positioning system 1775 provides the velocity Vₑₑ. If the positioning system provides the processor with only the boat's position, then the processor can compute Vₑₑ by differentiating the position. The processor can use Vₑₑ to compute the ocean current V_{c} in step 1780. The ocean current can now be output 1785. In some cases, it will be advantageous for the system to create an ocean current map, i.e., 940.

Wind velocity W_{b} measured on board the boat is measured in the boat's moving frame of reference. Step 1795 converts W_{b} to wind velocity relative to the water W_{w} by subtracting the boat's velocity relative to the water using W_{w}=W_{b}−V_{ew}. This assumes that the wind velocity is reported relative to true north. If it is not, the processor can apply the correction the same way it corrects using the heading offset. In some embodiments, the processor could receive remote wind readings, for example, from a nearby buoy. In this case, the wind velocity Wₑ is in a frame of reference fixed to the earth. In this case, the processor would correct the wind data to the water's frame of reference by subtracting the current speed: W_{w}=Wₑ−V_{ew}. The ocean-referenced wind can now be output 1799. The velocity of the wind, measured relative to the moving water enables the computation of the angle of the wind relative to both the sails and the heading of the boat. This wind velocity is fundamental to measuring the performance of a racing sailboat. Likewise, the ocean-referenced wind direction determines the ranking of each boat during a race, especially when racing towards or away from the wind direction.

There are many variations of this preferred embodiment, and many AOA Systems may be simpler. For example, the preferred embodiment can be used on a sailboat without a canted keel by mounting the ADVS transducer on a fixed keel or on the hull. The processor could default to a canting angle of zero, allowing it to vary from zero only if a canting angle sensor reports a non-zero number. A canting angle of zero causes the processor to correct for canting angle by using an identity matrix I, where v=Iv for any vector v. Alternatively, a user setting in the processor code could instruct the processor to skip the step of correcting for a canted keel. In another embodiment, processors used on boats with fixed keels could entirely eliminate the processing required for the canting keel. In another embodiment, the processing steps can be performed in a different order than described above. In another embodiment, multiple steps can be merged into one step.

In another embodiment, an AOA system mounted on a diverter includes the same components as a comprehensive sailboat AOA System 1600, with the exception of the canting angle sensor 1650 and the wind sensor 1660. Otherwise, each diverter is equipped with an ADVS 1610 and 1300, and a sensor package 1320 that includes a tilt sensor 1630 and a position sensor 1640. The processor 1620 could be mounted on the diverter, or it could be located on the seismic ship, with the connection between diverter and seismic ship being made by a radio link. While a long electrical cable could substitute, a cable is often impractical compared with a radio link. In another embodiment, a useful diverter AOA System could eliminate the tilt sensor 1630.

In another embodiment, a boat without tilt sensors, or with tilt sensors that cannot send data to the processor, or with tilt sensors judged untrustworthy, the rotation to surface referenced velocity 1740 can be performed by assuming zero vertical velocity. In yet other embodiments, not all of the output information is required. Some watercraft that need an AOA may not need ocean-referenced wind, or the ocean current.

A bottom-mounted device such as a turbine could use a simple AOA System embodiment. If a bottom-mounted turbine only needs to know its AOA to maximize its efficiency, it could do without the canting angle, tilt angle, or heading data. Since it is fixed to the bottom, it does not need any input for its position or velocity over the earth. It does not need the wind data. Its processing can then comprise only steps 1715, 1720, and 1750. A turbine could use the same processor as a complete sailboat AOA System, as explained earlier, or it could use its own, simplified processor.

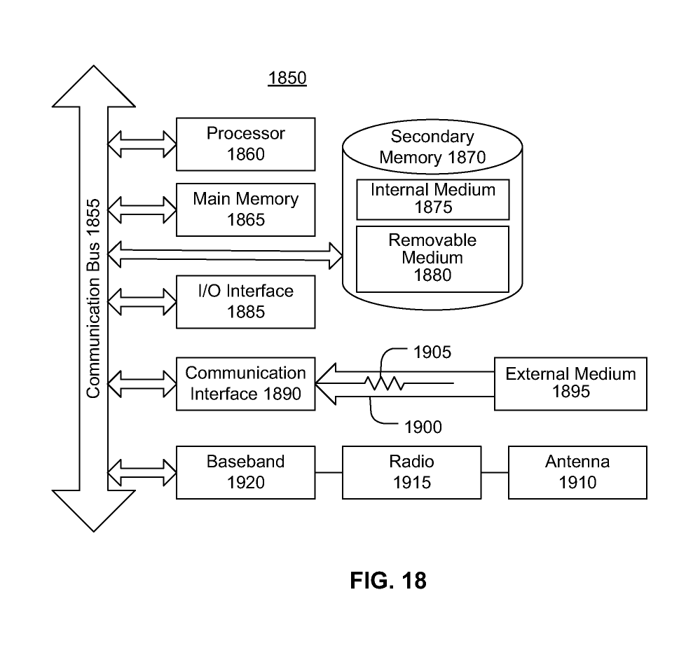

FIG. 18 is a block diagram illustrating an example wired or wireless system 1850 that may be used in connection with various embodiments described herein. For example the system 1850 may be used as or in conjunction with the AOA System 1600 and method 1700 discussed above with respect to FIGS. 16 and 17. The system 1850 can be a conventional personal computer, computer server, personal digital assistant, smart phone, tablet computer, or any other processor enabled device that is capable of wired or wireless data communication. Other computer systems and/or architectures may be also used, as will be clear to those skilled in the art.

The system 1850 preferably includes one or more processors, such as processor 1860. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 1860.

The processor 1860 is preferably connected to a communication bus 1855. The communication bus 1855 may include a data channel for facilitating information transfer between storage and other peripheral components of the system 1850. The communication bus 1855 further may provide a set of signals used for communication with the processor 1860, including a data bus, address bus, and control bus (not shown). The communication bus 1855 may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or standards promulgated by the Institute of Electrical and Electronics Engineers (“IEEE”) including IEEE 488 general-purpose interface bus (“GPIB”), IEEE 696/S-100, and the like.

System 1850 preferably includes a main memory 1865 and may also include a secondary memory 1870. The main memory 1865 provides storage of instructions and data for programs executing on the processor 1860. The main memory 1865 is typically semiconductor-based memory such as dynamic random access memory (“DRAM”) and/or static random access memory (“SRAM”). Other semiconductor-based memory types include, for example, synchronous dynamic random access memory (“SDRAM”), Rambus dynamic random access memory (“RDRAM”), ferroelectric random access memory (“FRAM”), and the like, including read only memory (“ROM”).

The secondary memory 1870 may optionally include a internal memory 1875 and/or a removable medium 1880, for example a floppy disk drive, a magnetic tape drive, a compact disc (“CD”) drive, a digital versatile disc (“DVD”) drive, etc. The removable medium 1880 is read from and/or written to in a well-known manner. Removable storage medium 1880 may be, for example, a floppy disk, magnetic tape, CD, DVD, SD card, etc.

The removable storage medium 1880 is a non-transitory computer readable medium having stored thereon computer executable code (i.e., software) and/or data. The computer software or data stored on the removable storage medium 1880 is read into the system 1850 for execution by the processor 1860.

In alternative embodiments, secondary memory 1870 may include other similar means for allowing computer programs or other data or instructions to be loaded into the system 1850. Such means may include, for example, an external storage medium 1895 and an interface 1870. Examples of external storage medium 1895 may include an external hard disk drive or an external optical drive, or and external magneto-optical drive.

Other examples of secondary memory 1870 may include semiconductor-based memory such as programmable read-only memory (“PROM”), erasable programmable read-only memory (“EPROM”), electrically erasable read-only memory (“EEPROM”), or flash memory (block oriented memory similar to EEPROM). Also included are any other removable storage media 1880 and communication interface 1890, which allow software and data to be transferred from an external medium 1895 to the system 1850.

System 1850 may also include an input/output (“I/O”) interface 1885. The I/O interface 1885 facilitates input from and output to external devices. For example the I/O interface 1885 may receive input from a keyboard or mouse and may provide output to a display. The I/O interface 1885 is capable of facilitating input from and output to various alternative types of human interface and machine interface devices alike.

System 1850 may also include a communication interface 1890. The communication interface 1890 allows software and data to be transferred between system 1850 and external devices (e.g. printers), networks, or information sources. For example, computer software or executable code may be transferred to system 1850 from a network server via communication interface 1890. Examples of communication interface 1890 include a modem, a network interface card (“NIC”), a wireless data card, a communications port, a PCMCIA slot and card, an infrared interface, and an IEEE 1394 fire-wire, just to name a few.

Communication interface 1890 preferably implements industry promulgated protocol standards, such as Ethernet IEEE 802 standards, Fiber Channel, digital subscriber line (“DSL”), asynchronous digital subscriber line (“ADSL”), frame relay, asynchronous transfer mode (“ATM”), integrated digital services network (“ISDN”), personal communications services (“PCS”), transmission control protocol/Internet protocol (“TCP/IP”), serial line Internet protocol/point to point protocol (“SLIP/PPP”), and so on, but may also implement customized or non-standard interface protocols as well.

Software and data transferred via communication interface 1890 are generally in the form of electrical communication signals 1905. These signals 1905 are preferably provided to communication interface 1890 via a communication channel 1900. In one embodiment, the communication channel 1900 may be a wired or wireless network, or any variety of other communication links. Communication channel 1900 carries signals 1905 and can be implemented using a variety of wired or wireless communication means including wire or cable, fiber optics, conventional phone line, cellular phone link, wireless data communication link, radio frequency (“RF”) link, or infrared link, just to name a few.

Computer executable code (i.e., computer programs or software) is stored in the main memory 1865 and/or the secondary memory 1870. Computer programs can also be received via communication interface 1890 and stored in the main memory 1865 and/or the secondary memory 1870. Such computer programs, when executed, enable the system 1850 to perform the various functions of the present invention as previously described.

In this description, the term “computer readable medium” is used to refer to any non-transitory computer readable storage media used to provide computer executable code (e.g., software and computer programs) to the system 1850. Examples of these media include main memory 1865, secondary memory 1870 (including internal memory 1875, removable medium 1880, and external storage medium 1895), and any peripheral device communicatively coupled with communication interface 1890 (including a network information server or other network device). These non-transitory computer readable mediums are means for providing executable code, programming instructions, and software to the system 1850.

In an embodiment that is implemented using software, the software may be stored on a computer readable medium and loaded into the system 1850 by way of removable medium 1880, I/O interface 1885, or communication interface 1890. In such an embodiment, the software is loaded into the system 1850 in the form of electrical communication signals 1905. The software, when executed by the processor 1860, preferably causes the processor 1860 to perform the inventive features and functions previously described herein.

The system 1850 also includes optional wireless communication components that facilitate wireless communication over a voice and over a data network. The wireless communication components comprise an antenna system 1910, a radio system 1915 and a baseband system 1920. In the system 1850, radio frequency (“RF”) signals are transmitted and received over the air by the antenna system 1910 under the management of the radio system 1915.

In one embodiment, the antenna system 1910 may comprise one or more antennae and one or more multiplexors (not shown) that perform a switching function to provide the antenna system 1910 with transmit and receive signal paths. In the receive path, received RF signals can be coupled from a multiplexor to a low noise amplifier (not shown) that amplifies the received RF signal and sends the amplified signal to the radio system 1915.

In alternative embodiments, the radio system 1915 may comprise one or more radios that are configured to communicate over various frequencies. In one embodiment, the radio system 1915 may combine a demodulator (not shown) and modulator (not shown) in one integrated circuit (“IC”). The demodulator and modulator can also be separate components. In the incoming path, the demodulator strips away the RF carrier signal leaving a baseband receive audio signal, which is sent from the radio system 1915 to the baseband system 1920.

If the received signal contains audio information, then baseband system 1920 decodes the signal and converts it to an analog signal. Then the signal is amplified and sent to a speaker. The baseband system 1920 also receives analog audio signals from a microphone. These analog audio signals are converted to digital signals and encoded by the baseband system 1920. The baseband system 1920 also codes the digital signals for transmission and generates a baseband transmit audio signal that is routed to the modulator portion of the radio system 1915. The modulator mixes the baseband transmit audio signal with an RF carrier signal generating an RF transmit signal that is routed to the antenna system and may pass through a power amplifier (not shown). The power amplifier amplifies the RF transmit signal and routes it to the antenna system 1910 where the signal is switched to the antenna port for transmission.

The baseband system 1920 is also communicatively coupled with the processor 1860. The central processing unit 1860 has access to data storage areas 1865 and 1870. The central processing unit 1860 is preferably configured to execute instructions (i.e., computer programs or software) that can be stored in the memory 1865 or the secondary memory 1870. Computer programs can also be received from the baseband processor 1910 and stored in the data storage area 1865 or in secondary memory 1870, or executed upon receipt. Such computer programs, when executed, enable the system 1850 to perform the various functions of the present invention as previously described. For example, data storage areas 1865 may include various software modules (not shown) that are executable by processor 1860.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, and methods described in connection with the embodiments disclosed herein can be implemented or performed with a general purpose processor, a digital signal processor (“DSP”), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

The above figures may depict exemplary configurations for the invention, which is done to aid in understanding the features and functionality that can be included in the invention. The invention is not restricted to the illustrated architectures or configurations, but can be implemented using a variety of alternative architectures and configurations. Additionally, although the invention is described above in terms of various exemplary embodiments and implementations, it should be understood that the various features and functionality described in one or more of the individual embodiments with which they are described, but instead can be applied, alone or in some combination, to one or more of the other embodiments of the invention, whether or not such embodiments are described and whether or not such features are presented as being a part of a described embodiment. Thus the breadth and scope of the present invention, especially in the following claims, should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; and adjectives such as “conventional,” “traditional,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, a group of items linked with the conjunction “and” should not be read as requiring that each and every one of those items e present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A watercraft angle of attack system, wherein the system comprises:
an acoustic Doppler velocity sensor that measures velocity of the watercraft relative to a volume of water remote from the watercraft so as to reduce watercraft-induced disturbance of the velocity in the volume of water;
a non-transitory computer readable medium configured to store executable programmed modules;
a processor communicatively coupled with the non-transitory computer readable medium configured to execute programmed modules stored therein;
a receiving module element stored in the non-transitory computer readable medium and configured to be executed by the processor, the receiving module element configured to receive real time data from the acoustic Doppler velocity sensor;
a computing module element stored in the non-transitory computer readable medium and configured to be executed by the processor, the computing module element configured to compute angle of attack of the watercraft through water based in part on the real time data received from the acoustic Doppler velocity sensor; and
a reporting module element stored in the non-transitory computer readable medium and configured to be executed by the processor, the reporting module element configured to report the computed angle of attack of the watercraft relative to the water.

2. The system of claim 1, further including a tilt sensor, and the receiving element configured to receive real time data from the tilt sensor, and the computing module element configured to compute angle of attack of the watercraft relative to water based in part on the real time data received from the tilt sensor.

3. The system of claim 2, further including a keel canting angle sensor, and the receiving element configured to receive real time data from the keel canting angle sensor and the computing module element configured to compute angle of attack of the watercraft relative to water based in part on the real time data received from the keel canting angle sensor.

4. The system of claim 1, further including a heading sensor, and the receiving element configured to receive real time data from the heading sensor, and the computing module element configured to compute the velocity of the watercraft relative to water based in part on the real time data received from the heading sensor.

5. The system of claim 4, further including a position sensor, and the receiving element configured to receive real time data from the position sensor, and the computing module element configured to compute current velocity of the water relative to the earth based in part on the real time data received from the position sensor.

6. The system of claim 5 wherein the computing module element is configured to compute the velocity of the watercraft relative to the earth by differentiating position data from the position sensor.

7. The system of claim 5, wherein the computing module element is configured to compute a plurality of current velocities based in part on the real time data received from the acoustic Doppler velocity sensor, and the displaying module element is configured to display a map of the computed current velocities.

8. The system of claim 5, further including a wind velocity sensor, and the receiving element configured to receive real time data from the wind velocity sensor, the computing module element configured to compute wind velocity in a water frame of reference, and further including a displaying module element stored in the non-transitory computer readable medium and configured to be executed by the processor, the displaying module element configured to display the wind velocity in the water frame of reference.

9. The system of claim 1, wherein the reporting module element is configured to report the computed angle of attack of the watercraft relative to the water to an external device.

10. The system of claim 1, further including user input and the processor communicatively coupled with the user input.

11. The system of claim 1, wherein the system reports two components of angle of attack, comprising a horizontal angle and a vertical angle.

12. A watercraft angle of attack system, comprising:
a sensor assembly, including:
a heading sensor; and
an acoustic Doppler velocity sensor that measures velocity of the watercraft relative to a volume of water remote from the watercraft so as to reduce watercraft-induced disturbance of the velocity in the volume of water;
a non-transitory computer readable medium configured to store executable programmed modules;
a processor communicatively coupled with the non-transitory computer readable medium configured to execute programmed modules stored therein;
a receiving module element stored in the non-transitory computer readable medium and configured to be executed by the processor, the receiving module element configured to receive real time data from the sensors of the sensor assembly; and
a computing module element stored in the non-transitory computer readable medium and configured to be executed by the processor, the computing module element configured to compute angle of attack of the watercraft through the water and velocity of the watercraft through the water in earth coordinates;

13. The system of claim 12 further including a display module element stored in the non-transitory computer readable medium and configured to be executed by the processor, the display module element configured to display angle of attack of the watercraft and velocity of the watercraft relative to the water.

14. The system of claim 12, further including a position sensor, and the receiving element configured to receive real time data from the position sensor, and the computing module element configured to compute current velocity of the water relative to the earth based in part on the real time data received from the position sensor.

15. The system of claim 14, wherein the displaying module element is configured to display the current velocity.

16. The system of claim 12, further including a keel canting angle sensor, and the receiving element configured to receive real time data from the keel canting angle sensor and the computing module element configured to compute angle of attack of the watercraft relative to water based in part on the real time data received from the keel canting angle sensor.

17. The system of claim 12, further including a wind velocity sensor, and the receiving element configured to receive real time data from the wind velocity sensor, the computing module element configured to compute wind velocity in a water frame of reference, and the displaying module element configured to display the wind velocity in the water frame of reference.

18. The system of claim 12, further including a reporting module element stored in the non-transitory computer readable medium and configured to be executed by the processor, the reporting module element is configured to report the computed angle of attack of the watercraft relative to the water to an external device.

19. The system of claim 12, further including user input and the processor communicatively coupled with the user input.

20. The system of claim 12, wherein the system reports two components of angle of attack, comprising a horizontal angle and a vertical angle.

21. A watercraft angle of attack system, comprising:
a sensor assembly, including:
a heading sensor;
a position sensor;
a tilt sensor; and
an acoustic Doppler velocity sensor that measures velocity of the watercraft relative to a volume of water remote from the watercraft so as to reduce watercraft-induced disturbance of the velocity in the volume of water; and
a non-transitory computer readable medium configured to store executable programmed modules;
a processor communicatively coupled with the non-transitory computer readable medium configured to execute programmed modules stored therein;
a receiving module element stored in the non-transitory computer readable medium and configured to be executed by the processor, the receiving module element configured to receive real time data from the sensors of the sensor assembly;
a computing module element stored in the non-transitory computer readable medium and configured to be executed by the processor, the computing module element configured to compute:
angle of attack of the watercraft relative to water;
velocity of the watercraft through the water in earth coordinates; and
current velocity of the water relative to the earth.

22. The system of claim 21, further including a wind velocity sensor, and the receiving element configured to receive real time data from the wind velocity sensor, the computing module element configured to compute wind velocity in a water frame of reference, and the displaying module element configured to display the wind velocity in the water frame of reference.

23. The system of claim 21, wherein the computing module element is configured to compute a plurality of current velocities based in part on the real time data received from the acoustic Doppler velocity sensor, and the displaying module element is configured to display a map of the computed current velocities.
